(19) United States
(12) Patent Application Publication
(10) Pub. No.: US 2013/0231242 A1
(43) Pub. Date: Sep. 5, 2013

(54) PRESSURE SENSITIVE COATING FOR IMAGE FORMING

(71) Applicant: CHROMATIC TECHNOLOGIES, INC., Colorado Springs, CO (US)

(72) Inventors: Terrill Scott Clayton, Colorado Springs, CO (US); Timothy J. Owen, Colorado Springs, CO (US)

(21) Appl. No.: 13/782,611

(22) Filed: Mar. 1, 2013

Related U.S. Application Data
(60) Provisional application No. 61/605,714, filed on Mar. 1, 2012.

(51) Int. Cl. B41M 5/165; B41M 5/136; B41M 5/124

(52) U.S. Cl. CPC B41M 5/165; B41M 5/1246; B41M 5/136
USPC 503/201; 503/226; 106/31.01

(57) ABSTRACT

Dye and developer components of a leuco dye system are separately microencapsulated. The microcapsule walls are fragile to the point of being easily ruptured. The microcapsules are mixed combined into a coating composition that is applied to a substrate and dried. Forces applied to the substrate, such as by the application of fingers or a writing instrument, rupture the capsule to produce a color change by interaction of the leuco dye system components that are released upon rupture of the capsules.

### RELATED APPLICATIONS

This application claims priority to U.S. Provisional Application Ser. No. 61/605,714, filed Mar. 1, 2012, which application is hereby incorporated by reference in its entirety.

### BACKGROUND

Carbonless paper was developed in the 1950's (NCR) to satisfy the need of being able to produce a duplicate image of an original document. The image is developed when pressure is applied to an original top surface. The pressure generated by the tip of a pen crushes capsules containing a leuco dye releasing the dye which is in solution in one of a number of potential solvents. The dye solution then can react with an unencapsulated developer chemical such as an acidified clay or phenolic compound. The dye becomes protonated and develops a permanent color. Various patents have been granted for microencapsulation processes and coating processes to manufacture carbonless paper. The extent of the use of carbonless paper has been for producing duplicates of original documents.

Pressure-rupturable microcapsules may be formed in any suitable manner. For example, capsules formed from coacervation of gelatin, polycondensation of urea-formaldehyde, interfacial cross-linking, or hydrolysis of isoclyanatoamidine products may be used. The microencapsulation technology is shown generally, by way of example, in U.S. Pat. No. 4,317,743 issued to Chang et al., U.S. Pat. No. 6,620,571 issued to Katampe et al., as well as U.S. Pat. No. 6,162,485 issued to Chang, all of which are incorporated by reference to the same extent as though fully replicated herein.

### SUMMARY

The concept described herein advances the art by providing frangible microcapsules that can be mechanically crushed by light pressure to form an image on a coated surface. The concept involves producing leuco dye-containing capsules that do not contain developer and developer-containing capsules that do not contain leuco dye. The capsules are made using conventional resins and processes for microencapsulation techniques; however, the interior phase is formulated in a nonconventional way as described herein. The dye and the developer are soluble in an organic phase that is not miscible with water. The appropriate organic phase is chosen separately for the dye capsules and the developer capsules. The separately encapsulated materials may be recombined without any reaction between the dye and the developer. The capsules are frangible in the sense that the capsules burst upon receiving sufficient force. This releases the respective interior phases of the capsules which are then free to interact for a color change.

In one aspect, a coating composition is improved by the addition of pigment in the form of microcapsules. This is provided as a mixture of microcapsules including a first subportion of microcapsules that contain a leuco dye in a first internal phase, and a second subportion of microcapsules that contain a developer for the leuco dye in a second internal phase. The first and second subportion of microcapsules have frangible walls such that manually delivered forces are capable of rupturing the microcapsules to release the leuco dye and the developer for contact with one another with ensuing development of color.

In one aspect, the coating composition may be formulated as a liquid and applied to a substrate to form, for example, a roll of masking tape or a flexible sheet material once the coating is dried or cured. The masking tape may be used in painting where developed color assures users that the tape has been pressed against a support surface to assure bonding thereto. The coating may be placed on a flexible sheet. This sheet may be used for drawing or printing of images.

In one aspect, the coating composition may contain a plurality of microcapsule types, such as additional microcapsules having additional leuco dyes that react with the developer to produce additional colors. It is also possible to combine more than one dye/developer combination with different force tolerances, such that the coating provides a first color upon receiving a first level of force and a second color upon receiving a second level of force. Thus, where the amount of resin, such as urea formaldehyde resin, is varied during the microencapsulation process, different colors may be developed by different levels of force as applied to rupture the microcapsule walls. This concept is useful for artistic purposes, as well as in the manufacture of adhesive sheet that may be applied to articles in shipping or transit as a measure of how roughly a package has been treated on its journey.

The separate capsules may be mixed together and formulated into a coating that is relatively stable and has no significant color. The combined dye and developer coating, which is virtually colorless, may be applied to a substrate and cured to be a dry film that can be handled under normal light pressure conditions. When sufficient pressure is applied to the coating, the dye and developer capsules are crushed releasing the liquid contents, permitting the internal phase material of the dye capsules and developer capsules to combine. The colorless leuco dye reacts with the developer and to produce color, forming an image that can be permanent or semi-permanent.

Specific applications include adhesive tape that permanently changes color as it is pressed into position, for example, where the color change confirms to a painter that masking tape is actually adhering to an intended position. Another example is interactive decorative use where schoolchildren place adhesive tape or film on a desk or textbook and ‘finger paint’ designs.

### BRIEF DESCRIPTION OF THE DRAWINGS

FIG. 1 shows a substrate that supports one or more layers that contain a mixture of microencapsulated components of a leuco dye system where these components are released for a color-producing interaction upon rupture of the microcapsule walls'

FIG. 2 shows an image that may be produced by the rupturing of frangible microcapsule walls; and

FIG. 3 shows masking tape where the rupture of frangible microcapsule walls produces a color change which assures the tape is adhering well for use in the painting of a wall or floor.

### DETAILED DESCRIPTION

In accordance with the instrumentalities described herein, microcapsules containing amine-formaldehyde shell walls are prepared by emulsifying an oily material internal phase in an aqueous medium, and subsequently forming amine-formaldehyde walls around the internal phase by in situ polycondensation. A hydrophilic polymer is optionally added to at least one of the internal phase or the continuous aqueous phase. The hydrophilic polymer becomes incorporated into the microcapsule wall. The hydrophilic polymer may be pectin (methylated polygalacturonic acid) or a synthetic hydrophilic polymer, such as a chemically modified gelatin. The hydrophilic polymer may be suitably added to the internal phase in an amount ranging from 0.01 to 10% by weight and more typically about 0.15 to 3% based on the monomer and also dependent on the color of the resultant batch.

The hydrophilic polymer is alternatively added to the continuous aqueous phase. The hydrophilic polymer can be dissolved in the continuous aqueous phase where it functions as a viscosity modifier and wall component. Incorporating the hydrophilic polymer into the continuous aqueous phase provides a process for increased control over the size of the resultant microcapsules. The increased aqueous phase viscosity leads to smaller size average capsules. The hydrophilic polymer also plasticizes the microcapsule wall thereby providing better stability and control of the dye release mechanism. The amount of hydrophilic polymer added to the continuous aqueous phase varies with the nature of the hydrophilic polymer and the nature and amount of the other materials used in the composition. The amount is limited to an amount that does not interfere with capsule rupture and reaction of the color former with the developer. The hydrophilic polymer is preferably incorporated in the aqueous phase in an amount of about 0.01 to 10% by weight based on monomer used in the composition and more typically in an amount of 0.15 to 3%.

Useful hydrophilic polymers include synthetic and natural hydrophilic polymers. Representative examples of such hydrophilic polymers include gum arabic, gelatin, gelatin derivatives such as phthalated gelatins, cellulose derivatives such as hydroxy cellulose, carboxymethyl cellulose and the like, soluble starches such as dextrin and combinations thereof. A preferred class of hydrophilic polymers is chemically modified gelatin. Specific examples of chemically modified gelatins include Gelita™ polymers from Kind & Knox and, more particularly, Gelita™ 8104, 8105, 8106 and 8107. These polymers are modified from Type A or Type B gelatin.

In capsule manufacture, as aqueous phase serves as the continuous phase of an oil-in-water emulsion in which the oily core materials phase is dispersed. The aqueous phase includes agents known as emulsifiers and system modifiers to control the size and uniformity of the microcapsules and to produce individual mononuclear capsules in preference to clusters of microcapsules. Useful emulsifiers and system modifiers are well known in the art. Their selection will depend on the type of microencapsulation process used and the nature of the wall formers. For making melamine-formaldehyde microcapsules a combination of methylated polygalacturonic acid and sulfonated polystyrenes may be used. The polygalacturonic acid acts as both a stabilizer and a viscosity modifier for the aqueous phase, and the sulfonated polystyrenes aid in emulsification.

Typical examples of useful sulfonated polystyrenes are Versa TL500 and Versa TL503, products of National Starch Co. Useful sulfonated polystyrenes are generally characterized by a sulfonation degree of over 85% and preferably over 95%. The molecular weight of the sulfonated polystyrene is preferably greater than 100,000 and more preferably about 500,000-1,000,000 but other molecular weights can also be used. The sulfonated polystyrene is usually added to the aqueous phase in an amount of about 1 to 6% by weight. The quality of this product has also been found to vary with the method by which it is manufactured such that certain sulfonated polystyrenes are better than others.

Dye capsules and developer capsules are manufactured separately and subsequently combined as a mixture. The mixture preferably contains a ratio of dye:developer capsules ranging from 1:1 to 1:20 by weight to achieve a pressure sensitive coating of desirable color with minimal residual color. The following examples teach by way of example and not by limitation.

### EXAMPLE 1

### Microencapsulation with Gelatin in the Oil Phase

1. Into a stainless steel beaker, 110 g water and 4.6 g dry sodium salt of polyvinylbenzenesulfonic acid (VERSA) are weighed.

2. The beaker is clamped in place on a hot plate under an overhead mixer. A six-bladed, 45° pitch, turbine impeller is used on the mixer.

3. After thoroughly mixing, 4.0 g pectin (polygalacturonic acid methyl ester) is slowly sifted into the beaker. This mixture is stirred for 2 hours at room temperature (800-1200 rpm).

4. The pH is adjusted to 6.0 with 2% sodium hydroxide.

5. The mixer is turned up to 3000 rpm and the internal phase is added over a period of 10-15 seconds. Emulsification is continued for 10 minutes at a temperature of 25° -30° C.

6. After 20 minutes, the mixing speed is reduced to 2000 rpm, and a solution of melamine-formaldehyde prepolymer is slowly added. This prepolymer is prepared by adding 6.5 g formaldehyde solution (37%) to a dispersion of 3.9 g melamine in 44 g water. After stirring at room temperature for 1 hour the pH is adjusted to 8.5 with 5% sodium carbonate and then heated to 62° C. until the solution becomes clear (30 minutes).

7. At the start of emulsification, the hot plate is turned up so heating continues during emulsification.

8. The pH is adjusted to 6.0, using 5% phosphoric acid. The beaker is then covered with foil and placed in a water bath to bring the temperature of the preparation to 75° C. When 75° C. is reached, the hot plate is adjusted to maintain this temperature for a two hour cure time during which the capsule walls are formed.

9. After curing, mixing speed is reduced to 1800 rpm, formaldehyde scavenger solution (7.7 g urea and 7.0 g water) is added and the solution cured another 40 minutes.

10. After 40 minutes hold time, turn down the mixer rpm to 1100 and adjust the pH to 9.5 using a 20% NaOH solution and then allow to stir at 500 rpm overnight at room temperature.

The materials forming the internal phase are added in step 5 above, and the materials forming the aqueous phase are added in step 6. The total capsule weight preferably comprises from 5% to 30% of a melamine formaldehyde polymer, or another polymer known to the art that is suitable for microencapsulation. Melamine resin Cas# 9003-08-1 is particularly preferred. The remainder of the capsule constituting 70% to 95% of the capsule weight is the internal phase where the internal phase is formulated either for use as a dye capsule or as a developer capsule. Any system of a leuco dye and developer may be used.

Dye Capsule:

| Core Material | | Wt % |
|---|---|---|
| Blue Dye | Cas# 69898-40-4 | 1-20% |
| Hexamoll Dinch | Cas# 166412-78-8 | 80-99% |

Developer Capsule:

| Core Material | | Wt % |
|---|---|---|
| 4,4-Biphenol | Cas# 92-88-6 | 1-25% |
| Isopropyl myristate | Cas# 110-27-0 | 75-99% |

Dye Capsule:

| Core Material | | Wt % |
|---|---|---|
| Green Dye | Cas# 34372-72-0 | 1-20% |
| Dioctyl phthalate | Cas# 117-84-0 | 80-99% |

Developer Capsule:

| Core Material | | Wt % |
|---|---|---|
| 4,4-Biphenol | Cas# 92-88-6 | 1-25% |
| Diiso nonylphalate | 2855-12-0 | 75-99% |

### EXAMPLE 2

### Microencapsulation with Gelatin in the Aqueous Phase

### Model Laboratory Capsule Preparation

1. Into a stainless steel beaker, 110 g water and 4.6 g dry sodium salt of polyvinylbenzenesulfonic acid (VERSA) are weighed.

2. The beaker is clamped in place on a hot plate under an overhead mixer. A six-bladed, 45° pitch, turbine impeller is used on the mixer.

3. After thoroughly mixing, 4.0 g pectin (polygalacturonic acid methyl ester) is slowly sifted into the beaker.

4. 0.25-5.0 g gelatin (pellets or solution thereof) is added to the beaker containing pectin/versa with continuous stirring. This mixture is stirred for 2 hours at room temperature (800-1200 rpm).

5. The pH is adjusted to 6.0 with 2% sodium hydroxide.

6. The mixer is turned up to 3000 rpm and the internal phase is added over a period of 10-15 seconds. Emulsification is continued for 10 minutes at from 25° -30° C.

7. At the start of emulsification, the hot plate is turned up so heating continues during emulsification.

8. After 20 minutes, the mixing speed is reduced to 2000 rpm, and a solution of melamine-formaldehyde prepolymer is slowly added. This prepolymer is prepared by adding 6.5 g formaldehyde solution (37%) to a dispersion of 3.9 g melamine in 44 g water. After stirring at room temperature for 1 hour the pH is adjusted to 8.5 with 5% sodium carbonate and then heated to 62° C. until the solution becomes clear (30 minutes).

9. The pH is adjusted to 6.0, using 5% phosphoric acid. The beaker is then covered with foil and placed in a water bath to bring the temperature of the preparation to 75° C. When 75° C. is reached, the hot plate is adjusted to maintain this temperature for a two hour cure time during which the capsule walls are formed.

10. After curing, mixing speed is reduced to 1800 rpm, formaldehyde scavenger solution (7.7 g urea and 7.0 g water) is added and the solution cured another 40 minutes.

11. After 40 minutes hold time, turn down the mixer rpm to 1100 and adjust the pH to 9.5 using a 20% NaOH solution and then allow to stir at 500 rpm overnight at room temperature.

The materials forming the internal phase are added in step 6 above, and the materials forming the aqueous phase are added in step 7. The total capsule weight preferably comprises from 5% to 30% of a melamine formaldehyde polymer, or another polymer known to the art that is suitable for microencapsulation. Melamine resin Cas# 9003-08-1 is particularly preferred. The remainder of the capsule constituting 70% to 95% of the capsule weight is the internal phase where the internal phase is formulated either for use as a dye capsule or as a developer capsule. Any system of a leuco dye and developer may be used.

Dye Capsule:

| Core Material | | Wt % |
|---|---|---|
| Blue Dye | Cas# 69898-40-4 | 1-20% |
| Hexamoll Dinch | Cas# 166412-78-8 | 80-99% |

Developer Capsule:

| Core Material | | Wt % |
|---|---|---|
| 4,4-Biphenol | Cas# 92-88-6 | 1-25% |
| Isopropyl myristate | Cas# 110-27-0 | 75-99% |

Dye Capsule:

| Core Material | | Wt % |
|---|---|---|
| Green Dye | Cas# 34372-72-0 | 1-20% |
| Dioctyl phthalate | Cas# 117-84-0 | 80-99% |

Developer Capsule:

| Core Material | | Wt % |
|---|---|---|
| 4,4-Biphenol | Cas# 92-88-6 | 1-25% |
| Diiso nonylphalate | 2855-12-0 | 75-99% |

A typical coating composition using the microcapsules described above can be coated onto a substrate, such as Mylar or another plastic. Use on paper or plastic used in the manufacture of adhesive tape is particularly preferred.

| Ingredient | Wt (g) | Wt %% |
|---|---|---|
| Microcapsules | 4.94 g | 29% |
| Phenolic Resin (HRJ 4542 from | 11.54 g | 68% |
| Schenectady Chemical Co.) | | |
| Polyvinyl alcohol (airvol grade 205 | 0.26 g | 1.5% |
| from Air Products Co.) | | |
| Sequrez 755 (binder) | 0.26 g | 1.5% |

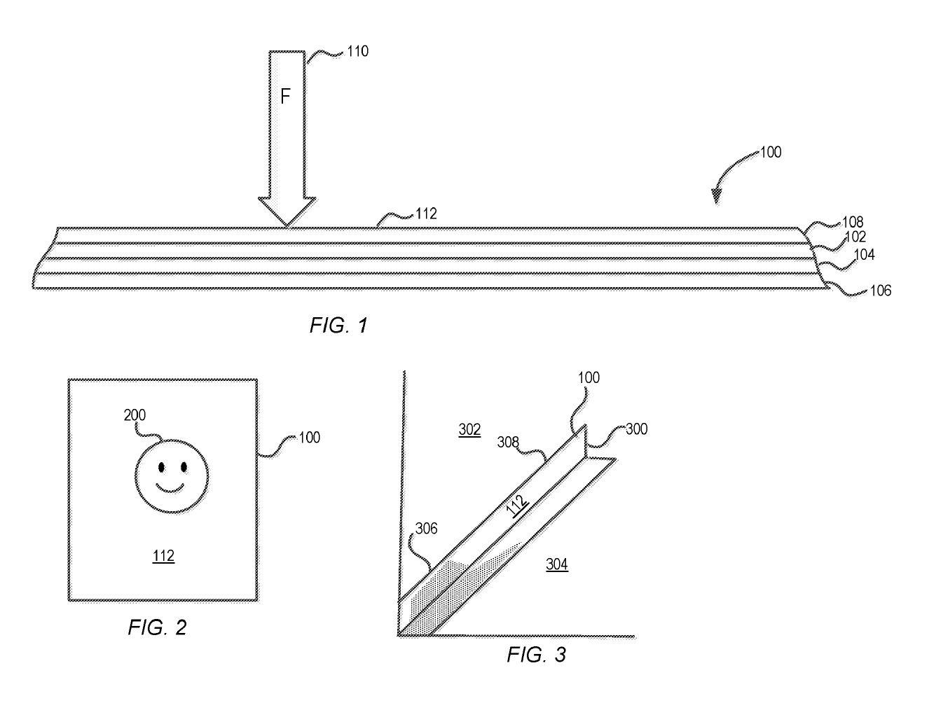

FIG. 1 shows a sheet material 100 that is provided with one or more coatings made from a mixture of frangible microcapsules as described above. A substrate 102 may be, for example, a flexible plastic or cellulosic sheet. A variety of options exist for applied coatings that contain a mixture of microcapsules. The microcapsules may be mixed into a liquid material and applied as layer 104 at the bottom of substrate 102. The layer 104 may be applied as a liquid that is then dried or cured to form a solid or gel material. An adhesive layer 106 is optionally included if it is desirable for the substrate 102 to adhere to other surfaces. If this is the case, then the layer 104 is optionally eliminated, as a commercially available adhesive may be modified by addition of the mixture of microcapsules such that color-forming occurs within the adhesive layer 106. Layer 108 is optionally included or eliminated, and may be a layer like layer 104, except one top-coating the substrate 102.

It will be appreciated that any system of commercially available leuco dye and developer materials may be used to produce pigments as described above in a range of colors. Color options include blue, red, green, black, magenta, orange, aqua, yellow, purple, etc. Color to color options may be green color that develops on yellow, purple color that develops on pink, red color that develops on yellow, etc.

A force 110 may be applied to top surface 112 for purposes of rupturing the frangible microcapsules. The force 110 may be applied manually using fingers or manually manipulated tools, such as a spatula or other implement. Where this occurs locally, by way of example, it is possible to drawn an image 200, as shown in FIG. 2, where the substrate 102 is a flexible sheet of plastic or cellulosic material. Where the substrate 102 is a masking tape 300 as shown in FIG. 3, the tape may be deployed at the intersection between a wall 302 and a floor 304. A color-developed area 306 indicates that the tape has been pressed sufficiently for adherence to the underlying floor 304 or wall 302, and an undeveloped area 308 indicates that the tape has been positioned but adherence is insufficient because the lack of developed color indicates the tape has not been pressed against the underlying floor 304 or wall 302.

Having described the invention in detail and by reference to preferred embodiments thereof, it will be apparent that modifications and variations are possible without departing from the scope of the invention defined in the appended claims.

We claim:

1. In a coating composition, the improvement comprising:
a mixture of microcapsules including
a first subportion of microcapsules that contain a leuco dye in a first internal phase, and
a second subportion of microcapsules that contain a developer for the leuco dye in a second internal phase;
the first and second subportion of microcapsules having frangible walls such that manually delivered forces are capable of rupturing the microcapsules to release the leuco dye and the developer for contact with one another with ensuing development of color.

2. The coating composition of claim 1 residing on a roll of masking tape.

3. The coating composition of claim 1 residing on a flexible sheet material.

4. The coating composition of claim 1 further comprising an additional subportion of microcapsules containing an additional leuco dye in an additional internal phase, the additional leuco dye having a capacity for interacting with the developer to make a different color than does the leuco dye in the first internal phase when the leuco dye in the first internal phase reacts with the developer.

5. A method of forming an image, comprising:
providing the coating composition of claim 1 in liquid form;
applying the coating composition to a substrate;
curing the coating composition; and
applying force to the substrate to rupture the frangible walls of the microcapsules in the microcapsule mixture.

6. The method of claim 5, wherein the substrate is masking tape and the method includes applying the masking tape to define a boundary for painting.
